(19) United States
(12) Patent Application Publication
(10) Pub. No.: US 2009/0229343 A1
(43) Pub. Date: Sep. 17, 2009

(54) SENSOR CONTROL APPARATUS AND SENSOR CONTROL SYSTEM

(75) Inventors: Yasuhiro Ishiguro, Nagoya (JP); Akihiro Kobayashi, Nagoya (JP); Satoru Abe, Nagoya (JP); Hiroshi Inagaki, Nagoya (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD., Nagoya (JP)

(21) Appl. No.: 12/402,012

(22) Filed: Mar. 11, 2009

(30) Foreign Application Priority Data
Mar. 13, 2008 (JP) 2008-063509

(51) Int. Cl. G01N 7/00

(52) U.S. Cl. 73/23.31

(57) ABSTRACT

In a sensor control apparatus (2), a GND1 terminal for signal-system circuits and a GND2 terminal for a power-system circuit are separately provided in an external circuit terminal section (31). The ground for the drive circuit of the power system and the ground for the drive circuits of the signal system are disposed independently of each other on a circuit board (20). Further, a first electrical path for connecting the circuit board (20) and an engine control unit is provided independently of a second electrical path for connecting the circuit board (20) and a battery. Therefore, even when a heater control circuit (28) is turned ON, the influence of heater current on an Ip1 cell/Vs cell control circuit (26), an Ip2 cell control circuit (27), and a CAN (Controller Area Network) circuit (29) can be suppressed. Further, since the ground for the sensor-system circuit and the ground for the CAN circuit (29) are rendered common, the layout of the ground wring can be simplified.

### BACKGROUND OF THE INVENTION

1. Field of the Invention

The present invention relates to a sensor control apparatus connectable to a gas sensor for detecting a specific component in a gas to be measured (hereinafter also referred to as “to-be-measured gas”), such as exhaust gas exhausted from an internal combustion engine, and which controls and drives the gas sensor.

2. Description of the Related Art

A gas sensor has conventionally been known for detecting NO_{X} (nitrogen oxides) within exhaust gas exhausted from the engine of an automobile. Such a gas sensor includes a first pumping cell and a second pumping cell. The first pumping cell pumps oxygen out of a to-be-measured gas (exhaust gas) introduced into a first measurement chamber or pumps oxygen into the first measurement chamber from outside the gas sensor, to thereby adjust the oxygen concentration of the to-be-measured gas to a predetermined level. The second pumping cell decomposes NO_{X} contained in the to-be-measured gas introduced from the first measurement chamber to a second measurement chamber and having an adjusted oxygen concentration, whereby a current corresponding to the concentration of NO_{X} flows between electrodes of the second pumping cell. A heater is provided in the gas sensor, and solid electrolyte members which constitute the cells are heated, whereby the cells are maintained in an activated state.

Such a gas sensor is connected to a sensor control apparatus. As a result of the sensor control apparatus driving the gas sensor, a current corresponding to the oxygen concentration flows through the first pumping cell (specifically, between the electrodes of the first pumping cell), and a current corresponding to the NO_{X} concentration flows through the second pumping cell. Current signals output from the cells are converted to voltage signals by a signal processing circuit within the sensor control apparatus, and are output to an external engine control unit (ECU or the like) as an oxygen concentration signal and an NO_{X} concentration signal. Meanwhile, supply of electricity to the heater, which partially constitutes the gas sensor, is controlled by a heater control circuit within the sensor control apparatus, whereby the heater current undergoes ON/OFF control.

The current from which the NO_{X} concentration is detected (that is, the current flowing through the second pumping cell) is on a nA (nano-ampere) order, whereas the heater current is on an A (ampere) order. Further, the signal processing circuit and the heater control circuit are formed on a common circuit board within the sensor control apparatus. Therefore, the conventional sensor control apparatus has a problem in that noise generated at the time of switching the heater ON/OFF is transmitted to the signal processing circuit, and accuracy in detecting NO_{X} concentration is lowered. A gas-concentration detection apparatus which has addressed such a problem is known (see, for example, Patent Document 1). In the gas-concentration detection apparatus, a ground pattern which sets a reference potential in a sensing circuit (signal processing circuit) and a ground pattern which sets a reference potential in a heater control circuit are provided such that the ground patterns diverge from a ground terminal portion. In the gas-concentration detection apparatus, since the flow of heater current to the sensing current can be prevented, the reference potential in the sensing circuit can be stabilized.

However, in the case where the ground terminal portion is commonly used, a problem arises in that, when the heater is ON, the large heater current load changes the output voltage of the signal processing circuit. This problem can be avoided by converting the output voltage (analog) of the signal processing circuit to a digital value and sampling the digital value during a period in which the heater is OFF. However, in the case where the digital values sampled without consideration of the ON/OFF states of the heater are averaged, such average value can deviate from the actual value. Accordingly, in order to minimize the influence of the heater current load on the signal processing circuit, desirably the ground of the signal processing circuit and the ground of the heater control circuit are separately provided.

Further, there is a demand for recent sensor control apparatuses for providing communication control for communicating with an ECU via serial communication such as a CAN (Controller Area Network), as well as electricity supply control for controlling the supply of electricity to a sensor element within a gas sensor, and electricity supply control for controlling the supply of electricity to a heater (see, for example, Patent Document 2). In this case, a sensor control apparatus must be designed such that a ground pattern which sets a reference potential for a communication circuit is additionally provided on a common circuit board within the sensor control apparatus so as to newly provide a communication ground.

[Patent Document 1] Japanese Patent Application Laid-Open (kokai) No. 2004-212284

[Patent Document 2] Japanese Patent Application Laid-Open (kokai) No. 2000-171435

3. Problems to Be Solved by the Invention

However, in the case where the ground pattern for the signal processing circuit, the ground pattern for the heater control circuit, and the ground pattern for the communication circuit are separately provided, the wiring for grounding the respective ground patterns becomes complex, which is undesirable.

### SUMMARY OF THE INVENTION

The present invention has been achieved for solving the above-mentioned problems of the prior art, and an object thereof is to provide a sensor control apparatus which can minimize output fluctuation of a signal processing circuit and a communication circuit even while a large current is being supplied to a heater, and which can simplify the layout of ground wiring.

In accordance with a first aspect (1) of the invention, the above object has been achieved by providing a sensor control apparatus connectable to a gas sensor, the gas sensor including a detection element for detecting concentration of a specific gas in a to-be-measured gas, and a heater for heating the detection element to an element activation temperature. The sensor control apparatus comprises a signal processing circuit which controls supply of electricity to the detection element and detects a voltage signal output from the detection element corresponding to the concentration of the specific gas; a heater control circuit which controls supply of electricity to the heater; and a communication circuit which outputs, as a concentration signal, the voltage signal detected by the signal processing circuit to a first external device by means of serial communication, wherein the signal processing circuit, the heater control circuit, and the communication circuit are implemented on a common circuit board; a power-system ground to which the heater control circuit is connected and a signal-system ground to which the signal processing circuit and the communication circuit are connected are independently provided on the circuit board; and the signal-system ground includes a first electrical path which establishes electrical connection between the circuit board and the first external device, and the power-system ground includes a second electrical path which is provided independently of the first electrical path and establishes electrical connection between the circuit board and a second external device different from the first external device.

In a preferred embodiment (2), the sensor control apparatus has a configuration according to (1) above, and is further characterized in that the gas sensor is an NO_{X} sensor for detecting concentration of NO_{X} as the concentration of the specific gas in the to-be-measured gas.

In a preferred embodiment (3), the sensor control apparatus has a configuration according to (1) or (2) above, and is further characterized in that the sensor control apparatus controls a sensor of an internal combustion engine; the first external device is an engine control unit for controlling the internal combustion engine; and the second external device is a battery for supplying electric power to the heater and the sensor control apparatus.

In accordance with a second aspect (4) of the invention, the above object has been achieved by providing a sensor control system comprising a gas sensor including a detection element for detecting concentration of a specific gas in a to-be-measured gas, and a heater for heating the detection element to an element activation temperature; and a sensor control apparatus according to (1) above connected to the gas sensor.

### EFFECT OF THE INVENTION

According to the sensor control apparatus (1) of the invention, the power-system ground and the signal-system ground are independently provided on the circuit board. In addition, the first electrical path of the signal-system ground for establishing electrical connection between the circuit board and the first external device and the second electrical path of the power-system ground for establishing electrical connection between the circuit board and the second external device are provided independently of one another. Therefore, even when electric current is supplied to the heater, the above configuration can prevent the large heater current flowing through the heater control circuit from influencing the respective outputs of the signal processing circuit and the communication circuit. Accordingly, accuracy in detecting the concentration of the specific gas can be improved. Further, since the signal processing circuit and the communication circuit are connected to a single signal-system ground, the layout of the ground wiring can be simplified.

According to the sensor control apparatus (2) of the invention, the following additional effect is achieved. Namely, the gas sensor control is suitably used for controlling a gas sensor which handles a very weak current, such as an NO_{X} sensor which generates a current corresponding to the NO_{X} concentration as one type of concentration-representing signal. That is, configuration (2) can prevent heater current flowing through the heater control circuit from influencing the respective outputs of the signal processing circuit and the communication circuit. Accordingly, accuracy in detecting NO_{X} concentration can be improved.

According to the sensor control apparatus (3) of the invention, the following additional effect is achieved. Namely, when the sensor control apparatus is used to control a sensor of an internal combustion engine, the engine control unit can receive an accurate concentration signal output from the sensor control apparatus via the communication circuit. In this manner, the engine controller can accurately control the internal combustion engine on the basis of the concentration signal.

### BRIEF DESCRIPTION OF THE DRAWINGS

FIG. 1 is a view schematically showing the configuration of an exhaust system and related components of an internal combustion engine system 1.

FIG. 2 is a view schematically showing the configuration of a sensor control apparatus 2 and an NO_{X} sensor 10 connected to the sensor control apparatus 2.

FIG. 3 is a view schematically showing the arrangement of electronic components, etc., mounted on a circuit board 20 of the sensor control apparatus 2.

FIG. 4 is a graph showing fluctuation of CAN output voltages (CAN communication signals) and a voltage fluctuation of a signal ground in a sensor control apparatus in which a single GND terminal is commonly used.

FIG. 5 is a graph showing fluctuation of CAN output voltages (CAN communication signals) and a voltage fluctuation of a signal ground in the sensor control apparatus of the present embodiment in which two GND terminals are separately provided.

FIG. 6 is a graph showing a fluctuation of the NO_{X} output of the sensor control apparatus in which a single GND terminal is commonly used.

FIG. 7 is a graph showing a fluctuation of the NO_{X} output of the sensor control apparatus of the present embodiment in which two GND terminals are separately provided.

### DESCRIPTION OF REFERENCE NUMERALS

Reference numerals used to identify various features shown in the drawings include the following:
2: sensor control apparatus
8: battery (second external device)
9: engine control unit (first external device)
10: NO_{X} sensor (gas sensor)
20: circuit board
26: Ip1 cell/Vs cell control circuit
27: Ip2 cell control circuit
28: heater control circuit
29: CAN circuit
30: sensor terminal section
31: external circuit terminal section
100: sensor element
180: heater

### DETAILED DESCRIPTION OF THE PREFERRED EMBODIMENTS

A sensor control apparatus according to an embodiment of the present invention will next be described in detail with reference to the drawings. However, the present invention should not be construed as being limited thereto.

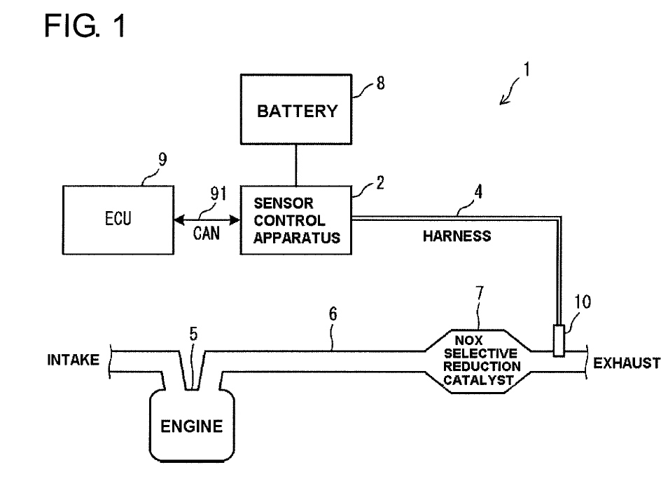

First, referring to FIG. 1, briefly described is the configuration of an internal combustion engine system 1 to which a sensor control apparatus 2, which is an example sensor control apparatus according to the present invention, is attached. The sensor control apparatus 2 controls an NO_{X} sensor 10 capable of detecting the concentration of NO_{X} (specific gas) in exhaust gas (a to-be-measured gas). The sensor control apparatus 2 is connected with the NO_{X} sensor 10, and constitutes the sensor control system together with the NO_{X} sensor 10. FIG. 1 is a view schematically showing the configuration of an exhaust system and related components of the internal combustion engine system 1.

As shown in FIG. 1, the internal combustion engine system 1 includes an engine 5 for driving an automobile. An exhaust pipe 6 is connected to the engine 5 so as to discharge exhaust gas exhausted from the engine 5 outside the automobile. An NO_{X} selective reduction catalyst 7 for cleaning the exhaust gas is provided in the middle of the path of the exhaust pipe 6. The NO_{X} selective reduction catalyst 7 causes NO_{X} to react with an NO_{X} reducer, whereby NO_{X} is converted to N₂ and H₂O, which are harmless, through know chemical reactions. Although not illustrated, an injector for injecting aqueous urea solution into the exhaust gas flowing through the exhaust pipe 6 is provided upstream of the NO_{X} selective reduction catalyst 7 (on the upstream side of the flow path of the exhaust gas).

The NO_{X} sensor 10 for detecting the concentration of NO_{X} in the exhaust gas having passed trough the NO_{X} selective reduction catalyst 7 is disposed in the path of the exhaust pipe 6 located downstream of the NO_{X} selective reduction catalyst 7. The NO_{X} sensor 10 is electrically connected via a harness (a bundle of signal wires) 4 to the sensor control apparatus 2, which is disposed at a position separate from the NO_{X} sensor 10. The NO_{X} sensor 10 detects NO_{X} concentration under control of the sensor control apparatus 2. The sensor control apparatus 2 drives the NO_{X} sensor 10, while receiving electrical power from a battery 8. The sensor control apparatus 2 outputs a detection signal (concentration signal), which represents the NO_{X} concentration detected by use of the NO_{X} sensor 10, to an engine control unit 9 (hereinafter also referred to as the “ECU 9”), which is connected to the sensor control apparatus 2 via a CAN (Controller Area Network) for automobiles 91.

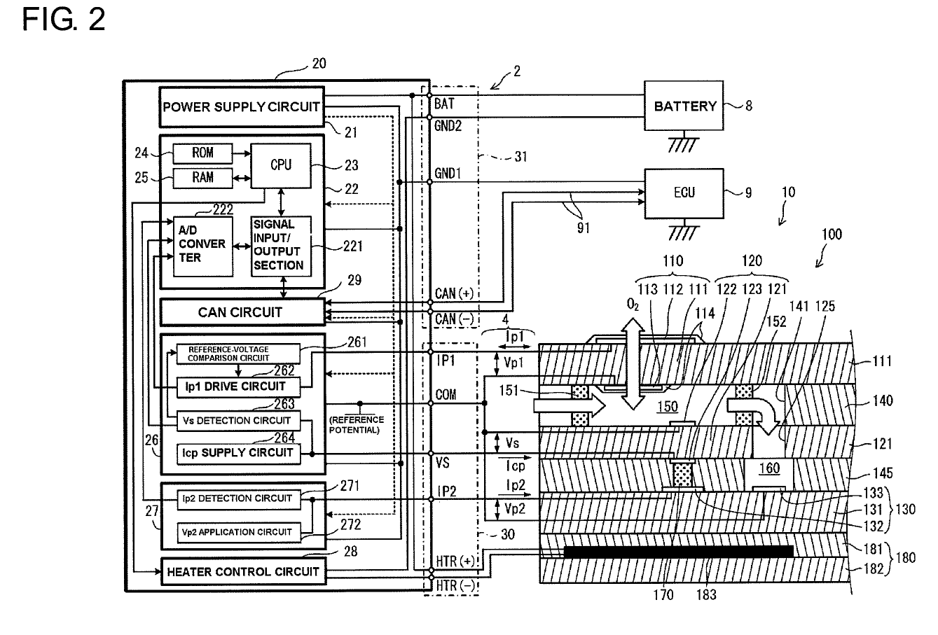

Next, the sensor control apparatus 2 and the NO_{X} sensor 10 will be described with reference to FIG. 2. FIG. 2 shows the schematic configuration of the sensor control apparatus 2 and the NO_{X} sensor 10 connected to the sensor control apparatus 2. FIG. 2 shows, in section, the internal structure of a front end portion of the sensor element 100 of the NO_{X} sensor 10. The left side in FIG. 2 is the front side of the sensor element 100.

The NO_{X} sensor 10 has a structure such that the sensor element 100 assuming the form of a narrow elongated plate is held in a housing (not shown) used to attach the NO_{X} sensor 10 to the exhaust pipe 6 (see FIG. 1). The harness 4 with a connector for taking out a signal output from the sensor element 100 extends from the NO_{X} sensor 10. Further, the harness 4 is connected to a sensor terminal section 30 of the sensor control apparatus 2, which is mounted at a position separate from the NO_{X} sensor 10, as described above. Thus, the NO_{X} sensor 10 and the sensor control apparatus 2 are electrically connected.

The structure of the sensor element 100 will next be described. As shown in FIG. 2, the sensor element 100 is configured such that three plate-like solid electrolyte members 111, 121 and 131 are arranged in layers with insulators 140 and 145 of alumina or the like intervening therebetween. A heater 180 is provided on the external side (lower side in FIG. 2) of the solid electrolyte member 131. The heater 180 includes laminated sheet-like insulating layers 181 and 182, which contain a predominant amount of alumina, and a heater pattern 183, which contains a predominant amount of Pt and is embedded between the insulating layers 181 and 182.

The solid electrolyte members 111, 121 and 131 are formed from zirconia and have oxygen-ion conductivity when heated to an activation temperature. Porous electrodes 112 and 113 are provided on respective opposite surfaces of the solid electrolyte member 111 with respect to the direction of lamination of the sensor element 100 such that the electrodes 112 and 113 sandwich the solid electrolyte member 111. The electrodes 112 and 113 are formed from Pt, a Pt alloy, cermet which contains Pt and ceramic, or a like material. A porous protective layer 114 of ceramic is formed on the surface of each of the electrodes 112 and 113 for protecting the electrodes 112 and 113 from deterioration, which could otherwise result from exposure to a poisonous component contained in the exhaust gas.

By causing a current to flow between the electrodes 112 and 113, the solid electrolyte member 111 can pump oxygen, in either direction, between an atmosphere in contact with the electrode 112 (atmosphere external to the sensor element 100) and an atmosphere in contact with the electrode 113 (atmosphere in a first measurement chamber 150, described below). In the present embodiment, the solid electrolyte member 111 and the electrodes 112 and 113 are collectively called a first oxygen pump cell (hereinafter also referred as the “Ip1 cell”) 110.

Next, the solid electrolyte member 121 is disposed so as to face the solid electrolyte member 111 with the insulator 140 intervening therebetween. Also, porous electrodes 122 and 123 are provided on respective opposite surfaces of the solid electrolyte member 121 with respect to the direction of lamination of the sensor element 100, such that the electrodes 122 and 123 sandwich the solid electrolyte member 121. Similarly, the electrodes 122 and 123 are formed from Pt, a Pt alloy, cermet which contains Pt and ceramic, or a like material. The electrode 122 is formed on a side toward the solid electrolyte member 111.

A small space serving as the first measurement chamber 150 is formed between the solid electrolyte members 111 and 121. The electrode 113 on the solid electrolyte member 111 and the electrode 122 on the solid electrolyte member 121 are disposed in the first measurement chamber 150. When exhaust gas flowing through the exhaust pipe 6 (see FIG. 1) is introduced into the sensor element 100, the exhaust gas first enters the first measurement chamber 150. A first diffusion resistance portion 151 formed of porous ceramic is provided in the first measurement chamber 150 at a position located toward the front end of the sensor element 100. More specifically, the first diffusion resistance portion 151 serves as a partition between the interior and the exterior of the first measurement chamber 150, and is adapted to limit inflow of the exhaust gas per unit time into the first measurement chamber 150. Similarly, a second diffusion resistance portion 152 formed of porous ceramic is provided in the first measurement chamber 150 at a position located toward the rear end of the sensor element 100. The second diffusion resistance portion 152 serves as a partition between the first measurement chamber 150 and an opening portion 141 communicating with a second measurement chamber 160, described below, and is adapted to limit flow per unit time of the gas.

The solid electrolyte member 121 and the two electrodes 122 and 123 can cooperatively generate an electromotive force according to the difference in partial pressure of oxygen between atmospheres (an atmosphere in the first measurement chamber 150 and in contact with the electrode 122 and an atmosphere in a reference-oxygen chamber 170, described below, and in contact with the electrode 123) separated from each other by the solid electrolyte member 121. In the present embodiment, the solid electrolyte member 121 and the two electrodes 122 and 123 are collectively called an electromotive force cell or oxygen concentration cell (hereinafter also referred as the “Vs cell”) 120.

Next, the solid electrolyte member 131 is disposed so as to face the solid electrolyte member 121 with the insulator 145 intervening therebetween. Porous electrodes 132 and 133 are provided on the solid electrolyte layer 131 on a side opposite an interface with the solid electrolyte layer 121 and are formed from Pt, a Pt alloy, cermet which contains Pt and ceramic, or a like material.

The insulator 145 is absent at a position corresponding to the electrode 132 so as to form an independent small space serving as a reference-oxygen chamber 170. The electrode 123 of the Vs cell 120 is disposed in the reference-oxygen chamber 170. The reference-oxygen chamber 170 is filled with a porous body of ceramic. Also, the insulator 145 is absent at a position corresponding to the electrode 133 so as to form an independent small space serving as the second measurement chamber 160, which is separated from the reference-oxygen chamber 170 by the insulator 145. An opening portion 125 and the opening portion 141 are provided in the solid electrolyte member 121 and the insulator 140, respectively, so as to communicate with the second measurement chamber 160. As mentioned previously, the first measurement chamber 150 and the opening portion 141 are in fluid communication by means of the second diffusion resistance portion 152 intervening therebetween.

The solid electrolyte member 131 and the two electrodes 132 and 133 can cooperatively pump oxygen between atmospheres (an atmosphere to which the electrode 132 is exposed and an atmosphere in the second measurement chamber 160 and in contact with the electrode 133) separated from each other by the insulator 145. In the present embodiment, the solid electrolyte member 131 and the two electrodes 132 and 133 are collectively called a second pumping cell (hereinafter also referred to as the “Ip2 cell”) 130.

Next, the configuration of the sensor control apparatus 2 will be described. As shown in FIG. 2, a power supply circuit 21, a microcomputer 22, a CAN circuit 29, an Ip1 cell/Vs cell control circuit 26, an Ip2 cell control circuit 27, a heater control circuit 28, etc., are implemented on a circuit board 20 of the sensor control apparatus 2. The power supply circuit 21 receives electric power from the battery 8, to which the power supply circuit 21 is connected via a BAT terminal of an external circuit terminal section 31. The power supply circuit 21 is grounded at the ECU 9, to which the power supply circuit 21 is connected via a GND1 terminal. The microcomputer 22, the CAN circuit 29, the Ip1 cell/Vs cell control circuit 26, and the Ip2 cell control circuit 27 are connected to the power supply circuit 21 so as to receive electric power necessary for driving the respective circuits.

The microcomputer 22 includes a CPU 23 having a known structure, ROM 24, RAM 25, a signal input/output section 221 connected to the CPU 23, and an A/D converter 222 connected to the signal input/output section 221. The Ip1 cell/Vs cell control circuit 26 and the Ip2 cell control circuit 27 are connected to the A/D converter 222. Further, the heater control circuit 28 is connected to the CPU 23. The microcomputer 22 is connected to the ground potential of the ECU 9 via the GND1 terminal of the external circuit terminal section 31. Notably, in the following description, the expression “is connected to the ground potential” may be simply expressed as “is grounded.” With the above-described configuration, the Ip1 cell/Vs cell control circuit 26, the Ip2 cell control circuit 27, and the heater control circuit 28 drive the sensor element 100 and the heater 180 under control of the microcomputer 22. Further, the microcomputer 22 calculates oxygen concentration and NO_{X} concentration from the current Ip1 (specifically, a voltage signal converted from the current Ip1) and current Ip2 (specifically, a voltage signal converted from the current Ip2), respectively, which are input via the A/D converter 222 and the signal input/output section 221.

Next, the Ip1 cell/Vs cell control circuit 26 will be described. As shown in FIG. 2, the Ip1 cell/Vs cell control circuit 26 is composed of a reference-voltage comparison circuit 261, an Ip1 drive circuit 262, a Vs detection circuit 263, and an Icp supply circuit 264. The reference-voltage comparison circuit 261 is adapted to compare the voltage Vs between the electrodes 122 and 123 of the Vs cell 120 detected by the Vs detection circuit 263 with a reference voltage (e.g., 425 mV), and outputs the result of the comparison to the Ip1 drive circuit 262. The Ip1 drive circuit 262 is adapted to supply current Ip1 which flows between the electrodes 112 and 113 of the Ip1 cell 110 connected to the Ip1 drive circuit 262 via an IP1 terminal and a COM terminal of the sensor terminal section 30. Further, the Ip1 drive circuit adjusts the magnitude and direction of the current Ip1 based on the output of the reference-voltage comparison circuit 261. The Ip1 drive circuit 262 also detects the current Ip1 flowing between the electrodes 112 and 113 of the Ip1 cell 110. The detected current Ip1 (specifically, a voltage signal converted from the current Ip1) is output to the microcomputer 22.

The Vs detection circuit 263 is adapted to detect voltage Vs developed between the electrodes 122 and 123 connected to the Vs detection circuit 263 via a VS terminal and the COM terminal of the sensor terminal section 30. The Vs detection circuit 263 outputs the detected voltage to the reference-voltage comparison circuit 261. The Icp supply circuit 264 supplies a current Icp which flows between the electrodes 122 and 123 of the Vs cell 120 for pumping out oxygen from the first measurement chamber 150 into the reference-oxygen chamber 170. The electrode 113 of the Ip1 cell 110 exposed to the first measurement chamber 150, the electrode 122 of the Vs cell 120 exposed to the first measurement chamber 150, and the electrode 133 of the Ip2 cell 130 (described below) exposed to the second measurement chamber 160 are connected to a reference electric potential of the Ip1 cell/Vs cell control circuit 26 via the COM terminal of the sensor terminal section 30. Further, the Ip1 cell/Vs cell control circuit 26 is grounded at the ECU 9 via the GND1 terminal of the external circuit terminal section 31.

Notably, based on a comparison of a previously set reference voltage with the voltage Vs developed between the electrodes 122 and 123 of the Vs cell 120 performed by the reference-voltage comparison circuit 261, the magnitude and direction of the current Ip1 are adjusted such that the voltage between the electrodes 122 and 123 of the Vs cell 120 substantially coincides with the reference voltage. As a result, the Ip1 cell 110 pumps out oxygen from the first measurement chamber 150 to the exterior of the sensor element 100 or pumps oxygen into the first measurement chamber 150 from the exterior of the sensor element 100. In other words, the Ip1 cell 110 adjusts the oxygen concentration in the first measurement chamber 150 such that the voltage between the electrodes 122 and 123 of the Vs cell 120 is maintained at a constant value (reference voltage). Typically, the Ip1 cell 110 adjusts the oxygen concentration in the first measurement chamber to a low, constant value without substantially decomposing NO_{X} contained in the to-be-measured gas. The to-be-measured gas in the first measurement chamber 150 having a reduced oxygen concentration is introduced into the second measurement chamber 160 via the diffusion resistance 152.

Next, the Ip2 cell control circuit 27 will be described. As shown in FIG. 2, the Ip2 cell control circuit 27 includes an Ip2 detection circuit 271 and a Vp2 application circuit 272. The Ip2 detection circuit 271 is adapted to detect a current Ip2 flowing from the electrode 132 to the electrode 133 of the Ip2 cell 130. The Ip2 detection circuit 271 is connected to the electrode 132 via an IP2 terminal of the sensor terminal section 30, and is connected to the electrode 133 via the COM terminal of the sensor terminal section 30. Notably, the detected current Ip2 (specifically, a voltage signal converted from the current Ip2) is output to the microcomputer 22. The Vp2 application circuit 272 is adapted to apply a predetermined voltage Vp2 (e.g., a voltage of 450 mV of sufficient magnitude to decompose NO_{X} present in the second measurement chamber 160 into oxygen and nitrogen) between the electrodes 132 and 133 of the Ip2 cell 130, whereby oxygen is pumped out from the second measurement chamber 160 into the reference-oxygen chamber 170. The Ip2 cell control circuit 27 is grounded at the ECU 9 via the GND1 terminal of the external circuit terminal section 31.

Next, the heater control circuit 28 will be described. As shown in FIG. 2, the heater drive circuit 28 is controlled by the CPU 23 and is adapted to supply current to the heater pattern 183 of the heater 180, to thereby heat the solid electrolyte members 111, 121 and 131 (namely, the Ip1 cell 110, the Vs cell 120 and the Ip2 cell 130). The heater control circuit 28 includes known switching elements (e.g., an FET) for turning ON and turning OFF supply of electricity to the heater pattern.

The heater pattern 183 is a single electrode pattern extending in the heater 180. One end of the heater pattern 183 is connected to the BAT terminal of the external circuit terminal section via an HTR(+) terminal of the sensor terminal section 30, so that electric power from the battery 8 is supplied to the one end of the heater pattern 183. The other end of the heater pattern 183 is connected to the heater control circuit 28 via an HTR(−) terminal of the sensor terminal section 30. The heater control circuit 28 is connected to the ground potential of the battery 8 via a GND2 terminal of the external circuit terminal section 31. That is, unlike the other circuits, only the heater control circuit 28 is grounded via the GND2 terminal at the battery 8, which is independent from the ECU 9. In such a configuration, switching operation of the switching elements of the heater control circuit 28 is effected through PWM (pulse width modulation) power-supply control performed by the CPU 23, whereby well-known control for supplying current to the heater pattern 183 is performed. Notably, in order to perform PWM power-supply control for supplying current to the heater pattern 183, the heater control circuit 28 may detect the impedance of the sensor element 100 (specifically, the impedance of the Vs cell 120) and calculate the duty ratio of electrical power to be supplied to the heater 180 such that the detected impedance coincides with a target value. Alternatively, the heater control circuit 28 may calculate the duty ratio of electric power supplied to the heater 180 based on the operation state of the internal combustion engine. Since the specific method for performing PWM power-supply control for supplying current to the heater pattern 183 is known, its description is omitted.

Next, the CAN circuit 29 will be described. As shown in FIG. 2, the CAN circuit 29 is adapted to communicate with the ECU 9 through a CAN (Controller Area Network). The CAN circuit 29 is connected to the CPU 23 via the signal input/output section 221, and is connected to CAN(+) and CAN(−) terminals of the external circuit terminal section 31. The CAN(+) and CAN(−) terminals are connected to the ECU 9 via a CAN 91. Thus, CAN communications can be performed between the CPU 23 and the ECU 9; and information representing oxygen concentration based on the current Ip1 and information representing NO_{X} concentration based on the current Ip2, which concentrations are calculated by the microcomputer 22 (the CPU 23), are output through the signal input/output section 121. Further, the CAN circuit 29 is grounded at the ECU 9 via the GND1 terminal of the external circuit terminal section 31.

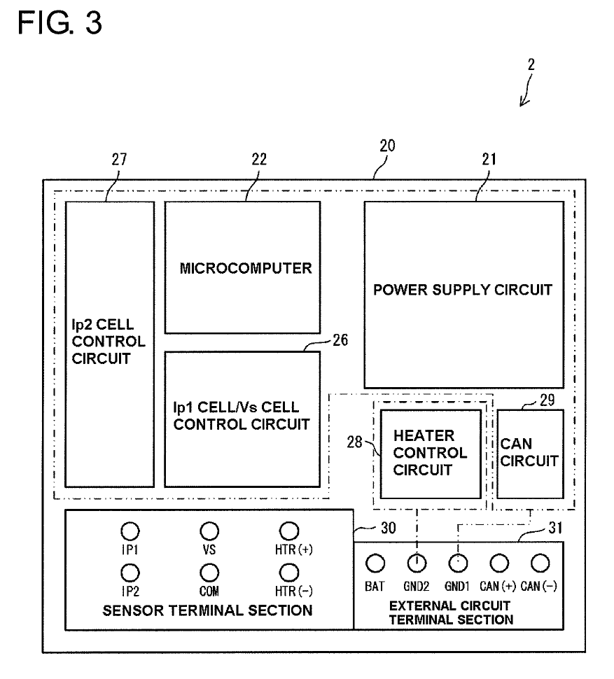

Next, the layout of the above-described circuits on the circuit board 20 of the sensor control apparatus 2 will be described with reference to FIG. 3. FIG. 3 is a view schematically showing the layout of electronic components, etc., mounted on the circuit board 20 of the sensor control apparatus 2. Notably, in order to facilitate description and understanding, the circuit board 20 is assumed to have the form of a rectangular plate; of four edges, an edge along which the sensor terminal section 30 and the external circuit terminal section 31 are disposed will be referred to as the “lower end”; and the edge opposite the lower end will be referred to as the “upper end.” Further, of the two remaining edges, an edge on the side toward the sensor terminal section 30 will be referred to as the “left end,” and an edge on the side toward the external circuit terminal section 31 will be referred to as the “right end.”

As shown in FIG. 3, the power supply circuit 21, the microcomputer 22, the Ip1 cell/Vs cell control circuit 26, the Ip2 cell control circuit 27, the heater control circuit 28, the CAN circuit 29, the sensor terminal section 30, and the external circuit terminal section (an ECU terminal section) 31 are implemented on the single circuit board 20 of the sensor control apparatus 2.

The Ip2 cell control circuit 27 is disposed between the sensor terminal section 30 and the upper end and along the left end. The power supply circuit 21 and the heater control circuit 28 are disposed between the external circuit terminal section 31 and the upper end and on the right-end side. The power supply circuit 21 is disposed between the heater control circuit 28 and the upper end. The microcomputer 22 is disposed near the upper end and is located between the Ip2 cell control circuit 27 and the power supply circuit 21.

Further, the Ip1 cell/Vs cell control circuit 26 is disposed between the microcomputer 22 and the sensor terminal section 30. The Ip1 cell/Vs cell control circuit 26 is disposed adjacent to the Ip2 cell control circuit 27 but away from the heater control circuit 28. The CAN circuit 29 is disposed on the lower-end side of the power supply circuit 21.

The sensor terminal section 30 includes the terminals (the IP1 terminal, the IP2 terminal, the VS terminal, the COM terminal, the HTR(+) terminal and the HTR(−) terminal) to which the wires of the harness 4 for connection with the NO_{X} sensor 10 (see FIG. 1) are connected, the terminals being disposed in a row within the sensor terminal section 30. The sensor terminal section 30 is disposed on the plate face of the circuit board 20 along one edge.

The external circuit terminal section 31 is disposed along the same edge along which the sensor terminal section 30 is disposed, such that the terminal sections 30 and 31 are located adjacent to each other. The external circuit terminal section 31 includes the above-described terminals arranged in a row; that is, the terminals (CAN(+), CAN(−)) to which the CAN 91 for communicating with the ECU 9 is connected; the terminal (BAT) to which a signal line extending from the battery 8 is connected; the terminal (GND2 terminal) for grounding the Ip1 cell/Vs cell control circuit 26 and the Ip2 cell control circuit 27, which are drive circuits of a signal system, and the heater control circuit 28, which is a drive circuit of a power system; and the terminal (GND1 terminal) for grounding the CAN circuit 29.

As described above, in the external circuit terminal section 31, the GND1 terminal for grounding the signal-system drive circuits (specifically, the power supply circuit 21, the microcomputer 22, the Ip1 cell/Vs cell control circuit 26, the Ip2 cell control circuit 27, and the CAN circuit 29) and the GND2 terminal for grounding the power-system drive circuit (specifically, the heater control circuit 28) are provided independently of each other. Further, the GND1 terminal is grounded to the ground potential of the ECU 9, and the GND2 terminal is grounded to the ground potential of the battery 8. That is, the ground of the power system and the ground of the signal system are provided independently of each other on the circuit board 20 and in the electrical path for establishing electrical connection between the circuit board 20 and the ECU 9 and the battery 8, which are external devices. For example, in the case where the drive circuits of the signal system and the drive circuit of the power system share a common ground, during a period of time in which the heater control circuit 28 is ON, the output values of the Ip1 cell/Vs cell control circuit 26 and the Ip2 cell control circuit 27 become greater than their actual values. Such a problem can be avoided by sampling digital values, obtained through A/D conversion of the output values, during a period in which the heater control circuit 28 is OFF. However, in the case where the digital values sampled without consideration of the ON/OFF states of the heater control circuit 28 are averaged, the oxygen concentration calculated on the basis of the current Ip1 and the NO_{X} concentration calculated on the basis of the current Ip2 tend to fluctuate greatly. In addition, since the current flowing through the CAN circuit 29 is very small as compared with the heater current, during a period in which the heater control circuit 28 is ON, the output voltage of the CAN circuit 29 also fluctuates. In contrast, in the case where, as in the present embodiment, the ground for the drive circuits of the signal system and the ground for the drive circuit of the power system are provided independently of each other, the influence of the heater current on the drive circuits of the signal system can be suppressed.

Further, since, independently of the heater control circuit 28, the power supply circuit 21 and the microcomputer 22 are grounded at the ECU 9 via the GND1 terminal, the influence of the heater current on the outputs of the power supply circuit 21 and the microcomputer 22 can be prevented.

Moreover, the GND1 terminal is commonly used for grounding the Ip1 cell/Vs cell control circuit 26 and the Ip2 cell control circuit 27 and for grounding the CAN circuit 29. Normally, the external circuit terminal section 31 must have three GND terminals, including that for the heater control circuit 28. However, the configuration of the present embodiment can reduce the number of the GND terminals to two. Thus, the layout of the ground wiring of the sensor control apparatus 2 can be simplified.

Next, an operation for detecting the oxygen concentration and the NO_{X} concentration by use of the NO_{X} sensor 10 will be described. As the temperature of the heater pattern 183 increases as a result of supply of drive current thereto from the heater control circuit 28, the solid electrolyte members 111, 121 and 131 shown in FIG. 2 and constituting the sensor element 100 of the NO_{X} sensor 10 are heated and thus activated. By this procedure, the Ip1 cell 110, the Vs cell 120 and the Ip2 cell 130 become operable.

The exhaust gas flowing through the exhaust pipe 6 (see FIG. 1) is introduced into the first measurement chamber 150 while its flow rate is limited by the first diffusion resistance portion 151. Meanwhile, the Icp supply circuit 264 supplies the current Icp which flows through the Vs cell 120 from the electrode 123 to the electrode 122. Thus, oxygen contained in the exhaust gas can receive electrons from the electrode 122 of negative polarity exposed to the first measurement chamber 150, to thereby become oxygen ions. The oxygen ions flow through the solid electrolyte member 121 and move into the reference-oxygen chamber 170. That is, as a result of the current Icp flowing between the electrodes 122 and 123, oxygen contained in the first measurement chamber 150 is transferred to the reference-oxygen chamber 170.

The Vs detection circuit 263 detects the voltage between the electrodes 122 and 123. The reference-voltage comparison circuit 261 compares the detected voltage with the reference voltage (425 mV). The result of the comparison is output to the Ip1 drive circuit 262. By means of adjusting the oxygen concentration within the first measurement chamber 150 such that the difference in electric potential between the electrodes 122 and 123 is maintained at a constant value of around 425 mV, the oxygen concentration of the exhaust gas contained in the first measurement chamber 150 approaches a predetermined value (10⁻⁸ atm to 10⁻⁹ atm).

In the case where the oxygen concentration of the exhaust gas introduced into the first measurement chamber 150 is lower than the predetermined value, the Ip1 drive circuit 262 supplies current Ip1 to the Ip1 cell 110 such that the electrode 112 assumes a negative polarity. In this manner, oxygen is pumped into the first measurement chamber 150 from the exterior of the sensor element 100. By contrast, in the case where the oxygen concentration of the exhaust gas introduced into the first measurement chamber 150 is higher than the predetermined value, the Ip1 drive circuit 262 supplies current Ip1 to the Ip1 cell 110 such that the electrode 113 assumes a negative polarity. In this manner, oxygen is pumped out of the first measurement chamber 150 to the exterior of the sensor element 100. The oxygen concentration can be detected from the magnitude and flow direction of the current Ip1 at this time. Notably, the oxygen concentration is calculated by the microcomputer 22 on the basis of the current Ip1 (specifically, a voltage signal converted from the current Ip1, typically as a voltage drop across a series connected resistor).

The exhaust gas whose oxygen concentration has been adjusted in the first measurement chamber 150 as described above is introduced into the second measurement chamber 160 via the second diffusion resistance portion 152. In the second measurement chamber 160, NO_{X} contained in the exhaust gas contacts the electrode 133 and is decomposed (reduced) into N₂ and O₂ by the catalytic effect of the electrode 133. Oxygen generated through decomposition receives electrons from the electrode 133, to thereby become oxygen ions. The oxygen ions flow through the solid electrolyte member 131 and move into the reference-oxygen chamber 170. At this time, residual oxygen not pumped out of the first measurement chamber 150 similarly moves into the reference-oxygen chamber 170 through the Ip2 cell 130. Thus, the current flowing through the Ip2 cell 130 consists of a current stemming from NO_{X} and a current stemming from the residual oxygen.

Since the residual oxygen not pumped out of the first measurement chamber 150 is adjusted to a predetermined concentration as mentioned previously, the current stemming from the residual oxygen can be considered substantially constant. Thus its effect on variation in the current stemming from NO_{X} is small. Therefore, a change in the current flowing through the Ip2 cell 130 is proportional to the NO_{X} concentration. In the sensor control apparatus 2, the microcomputer 22 detects the current Ip2 flowing through the Ip2 cell 130 (specifically, a voltage signal converted from the current Ip2) by use of the Ip2 detection circuit 271, and performs known calculation processing for compensating for offset current stemming from the residual oxygen, to thereby detect the NO_{X} concentration of the exhaust gas.

Next, evaluation tests were performed so as to confirm the effect of the present invention achieved by separately providing the ground for the drive circuits of the signal system and the ground for the drive circuit of the power system. In the evaluation tests, the influence of ON/OFF switching of the heater control circuit 28 on the output values of the sensor control apparatus 2 was examined. Specifically, in Example 1, fluctuations of output voltages (V) of the CAN-H and CAN-L lines (of opposite polarities) of the CAN communication bus and fluctuation of the output voltage (V) of the signal ground, which is a reference voltage for signals, were examined. In Example 2, fluctuation of the output voltage (V) of the Ip2 detection circuit 271 was examined. Notably, in both Examples 1 and 2, a sensor control apparatus in which the GND terminal for the drive circuits of the signal system and the GND terminal for the drive circuit of the power system are rendered common was used as a comparative sample.

### Example 1

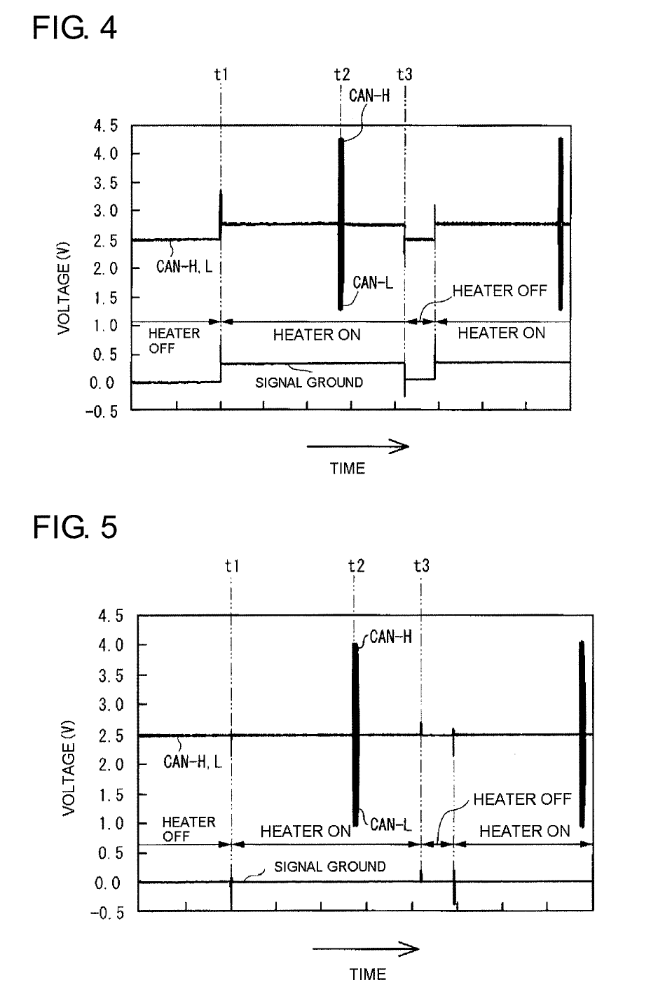

First, the results of Example 1 will be described with reference to FIGS. 4 and 5. FIG. 4 is a graph showing fluctuation in the CAN output voltages (CAN communication signal) and voltage fluctuation of the signal ground in a sensor control apparatus in which a single GND terminal is commonly used. FIG. 5 is a graph showing fluctuation in the CAN output voltages (CAN communication signal) and voltage fluctuation of the signal ground in the sensor control apparatus of the present embodiment in which two GND terminals are separately provided.

First, the results of examination of the output fluctuations of the sensor control apparatus in which a single GND terminal is commonly used will be described. As shown in FIG. 4, when the heater control circuit 28 was turned ON at time t1, the voltage of the signal ground, which had been 0 (V) during a previous OFF period, instantaneously increased, and then dropped to 0.3 (V). After that, the voltage of the signal ground was maintained at 0.3 (V) during a period in which the heater control circuit 28 was ON. Next, when the heater control circuit 28 was turned OFF at time t3, the voltage instantaneously dropped by a large amount, but immediately returned to 0 (V). After that, the voltage was maintained at 0 (V) during a period in which the heater control circuit 28 was OFF.

Meanwhile, the output voltages of the CAN-H and CAN-L lines were found to fluctuate as follows. When the heater was turned ON at time t1, the voltages of the CAN-H and CAN-L lines, which had been 2.5 (V) during the previous OFF period, instantaneously increased, and then dropped to 2.8 (V). After that, the voltages of the CAN-H and CAN-L lines were maintained at 2.8 (V) during a period in which the heater control circuit 28 was ON. Next, during communication between the CAN circuit 29 and the ECU 9 at time t2, the voltage of the CAN-H line instantaneously increased to 4.3 (V), and the voltage of the CAN-L line instantaneously dropped to 1.2 (V). After that, these voltages returned to 2.8 (V). When the heater control circuit 28 was turned OFF at time t3, the voltage instantaneously dropped by a large amount, but immediately returned to 2.5 (V). After that, the voltages were maintained at 2.5 (V) during a period in which the heater control circuit 28 was OFF. That is, during the period in which the heater control circuit 28 was ON, the voltages of the CAN-H and CAN-L lines increased by 0.3 (V), which is equal to the increase in output voltage of the signal ground during that period.

Next, the results of examination of the output fluctuation of the sensor control apparatus (the apparatus of the present invention) in which two GND terminals are separately provided will be described. As shown in FIG. 5, when the heater control circuit 28 was turned ON at time t1, the voltage of the signal ground, which had been 0 (V) during a previous OFF period, instantaneously dropped, but immediately returned to 0 (V). After that, the voltage of the signal ground was about 0 (V) during a period in which the heater control circuit 28 was ON. Next, when the heater control circuit 28 was turned OFF at time t3, the voltage instantaneously dropped by a small amount, but immediately returned to 0 (V). After that, the voltage was maintained at 0 (V) even when the heater control circuit 28 was turned ON and OFF.

Meanwhile, the output voltages of the CAN-H and CAN-L lines were found to fluctuate as follows. When the heater control circuit 28 was turned ON at time t1, the output voltage, which had been 2.5 (V) during the previous OFF period, instantaneously dropped by a small amount, but immediately returned to 2.5 (V). After that, the output voltage was maintained at 2.5 (V) during a period in which the heater control circuit 28 was ON. Next, during communication between the CAN circuit 29 and the ECU 9, the voltage of the CAN-H line instantaneously increased to 4.0 (V), and the voltage of the CAN-L line instantaneously dropped to 0.9 (V). After that, these voltages returned to 2.5 (V). When the heater control circuit 28 was turned OFF at time t3, the voltages instantaneously increased by a small amount, but immediately returned to 2.5 (V). After that, the voltages were maintained at 2.5 (V) even after the heater control circuit 28 was turned OFF.

The results of Example 1 show that, in the case of the sensor control apparatus employing a single common GND terminal, during a period in which the heater control circuit 28 is ON, the output voltage of the signal ground increases, and the output voltages of the CAN-H and CAN-L lines increase by an amount corresponding to the increase in the output voltage of the signal ground. The results also show that the output voltages greatly change at the time of turning the heater control circuit 28 ON and OFF. These results show that the sensor control apparatus was in a state in which the output voltages of the CAN-H and CAN-L lines are apt to be influenced by the heater current flowing through the heater control circuit 28. This is because the current flowing through the CAN circuit 29 is very small compared with the current flowing through the heater control circuit 28, and the GND terminal for the heater control circuit 28 and the GND terminal for the CAN circuit 29 are rendered common. Presumably, because of the influence of the heater current, the output voltages of the signal ground, the CAN-H line and the CAN-L line increased when the heater control circuit 28 was ON. In such a state, the CAN output fluctuates during a period in which the heater control circuit 28 is ON, and there is a possibility that the ECU 9 will fail to stably receive the CAN communication signal, which contains NO_{X} concentration information, etc., from the sensor control apparatus via the CAN 91.

In contrast, in case of the sensor control apparatus 2 of the present invention, fluctuation was hardly observed in the outputs of the signal ground and the CAN-H and CAN-L lines irrespective of ON/OFF switching of the heater control circuit 28. Further, the fluctuations at the time of turning the heater control circuit 28 ON and OFF were small compared with the case where a common GND terminal was used. Thus, the influence of the heater current flowing through the heater control circuit 28 on the CAN circuit 29 can be minimized. Presumably, because the influence of the heater current is minimized, the output voltages of the signal ground, the CAN-H line, and the CAN-L line hardly change even when the heater control circuit 28 is turned ON. That is, in the sensor control apparatus 2 of the present invention, since the output of the CAN circuit 29 is stable irrespective of the ON/OFF state of the heater control circuit 28, the ECU 9 can stably receive the CAN communication signal, which contains NO_{X} concentration information, etc., from the sensor control apparatus 2 via the CAN 91.

### Example 2

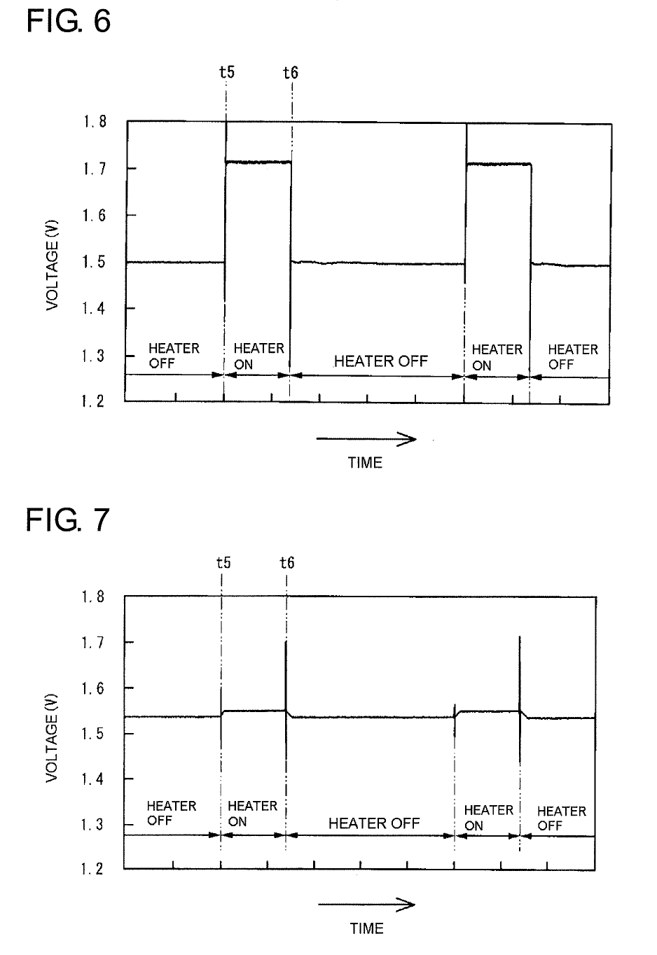

Next, the results of Example 2 will be described with reference to FIGS. 6 and 7. FIG. 6 is a graph showing fluctuation of the NO_{X} output of the sensor control apparatus in which a single GND terminal is commonly used. FIG. 7 is a graph showing fluctuation of the NO_{X} output of the sensor control apparatus of the present embodiment in which two GND terminals are separately provided. In Example 2, an NO_{X} output voltage converted from the Ip2 current detected by the Ip2 cell control circuit 27 was measured as an analog output representing the NO_{X} concentration.

First, the results of examination of the output fluctuation of the sensor control apparatus in which a single GND terminal is commonly used will be described. As shown in FIG. 6, when the heater control circuit 28 was turned ON at time t5, the NO_{X} output voltage, which had been 1.50 (V) during a previous OFF period, instantaneously increased and decreased, and then changed to 1.70 (V). After that, without returning to 1.50 (V), the NO_{X} output voltage remained at 1.70 (V) during a period in which the heater control circuit 28 was ON. Next, when the heater control circuit 28 was turned OFF at time t6, the NO_{X} output voltage instantaneously dropped by a large mount, but returned to 1.50 (V) after that.

Next, the results of examination of the output fluctuation of the sensor control apparatus (the apparatus of the present invention) in which two GND terminals are separately provided will be described. As shown in FIG. 7, when the heater control circuit 28 was turned ON at time t5, the NO_{X} output voltage, which had been 1.50 (V) during a previous OFF period, instantaneously increased and decreased, but immediately changed to 1.52 (V). After that, the NO_{X} output voltage remained at 1.52 (V) during a period in which the heater control circuit 28 was ON. Next, when the heater control circuit 28 was turned OFF at time t6, the NO_{X} output voltage instantaneously increased and decreased, but immediately returned to 1.50 (V). After that, the NO_{X} output voltage remained at 1.50 (V) during a period in which the heater control circuit 28 was OFF.

The results of Example 2 show that, in the case of the sensor control apparatus which employs a single common GND terminal, during a period in which the heater control circuit 28 is ON, the NO_{X} output voltage increases greatly. The results also show that the output voltage greatly changes at the time of turning the heater control circuit 28 ON and OFF. This demonstrates that the sensor control apparatus was in a state in which the NO_{X} output voltage is apt to be influenced by the heater current flowing through the heater control circuit 28. This is because the current (on the nA order) flowing through the Ip2 cell control circuit 27 is very small compared with the heater current flowing through the heater control circuit 28, and the GND terminal for the heater control circuit 28 and the GND terminal for the Ip1 cell/Vs cell control circuit 26 and the Ip2 cell control circuit 27 are rendered common. Presumably, because of the influence of the heater current, the NO_{X} output voltage increased when the heater control circuit 28 was ON. In such a state, during a period in which the heater control circuit 28 is ON, the NO_{X} output voltage fluctuates, and it is difficult to accurately detect NO_{X} concentration.

In contrast, in case of the sensor control apparatus 2 of the present invention, although the NO_{X} output voltage increased when the heater control circuit 28 was turned ON, the amount of increase was slight, and a difference was hardly observed. Further, fluctuations at the time of turning the heater control circuit 28 ON and OFF were quite small compared with the case where a common GND terminal is used. This is because the ground for the drive circuit of the power system and the ground for the drive circuits of the signal system are provided separately. Thus, the influence of the heater current flowing through the heater control circuit 28 on the output of the Ip2 cell control circuit 27 can be minimized. Presumably, because of the minimized influence of the heater current, the NO_{X} output voltage of the sensor control apparatus 2 hardly changed even when the heater control circuit 28 was turned ON. Accordingly, in the sensor control apparatus 2 of the present invention, since the output representing the NO_{X} concentration is stable irrespective of the ON/OFF state of the heater control circuit 28, the NO_{X} concentration can be detected accurately.

As described above, in the sensor control apparatus 2 of the present embodiment, the GND1 terminal for connecting the drive circuits of the signal system to the ground potential and the GND2 terminal for connecting the drive circuit of the power system to the ground potential are provided in the external circuit terminal section 31 independently of each other. Further, the GND1 terminal is connected to the ground potential of the ECU 9 (the first external device), and the GND2 terminal is connected to the ground potential of the battery 8 (the second external device). That is, the ground for the drive circuit of the power system and the ground for the drive circuits of the signal system are provided independently of each other on the circuit board 20 and in the electrical path for establishing electrical connection between the circuit board 20 and the ECU 9 and the battery 8, which are external devices. By virtue of this configuration, even when the heater control circuit 28 is turned ON, the influence of the heater current on the Ip1 cell/Vs cell control circuit 26 and the Ip2 cell control circuit 27 of the signal system and the CAN circuit 29 for communication can be suppressed. Accordingly, accuracy in detecting the NO_{X} concentration can be improved.

Further, since the GND1 terminal is shared by the ground for connecting the Ip1 cell/Vs cell control circuit 26 and the Ip2 cell control circuit 27 associated with the sensor element 100 to the ground potential and the ground for connecting the CAN circuit 29 to the ground potential, the number of GND terminals to be provided in the external circuit terminal section 31 can be decreased. Thus, the layout of the ground wiring in the sensor control apparatus 2 can be simplified.

Notably, the present invention is not limited to the above-described embodiment, and may be modified in various ways. For example, in the above-described embodiment, one end of the heater pattern 183 is connected to the BAT terminal via the HTR(+) terminal of the sensor terminal section 30, and the other end of the heater pattern 183 is connected to the heater control circuit 28 via the HTR(−) terminal. However, this circuit configuration may be modified such that one end of the heater pattern 183 is connected via the HTR(+) terminal to the heater control circuit 28, which is then connected to the BAT terminal, and the other end of the heater pattern 183 is connected to the ground potential of the battery 8 via the HTR(−) terminal.

### INDUSTRIAL APPLICABILITY

The present invention is applicable not only to a sensor control apparatus connected to an NO_{X} sensor, but also to a sensor control apparatus connected to a heated gas sensor for detecting the concentration of other specific gases within a to-be-measured gas, such as a hydrogen sensor, an HC sensor, etc.

It should further be apparent to those skilled in the art that various changes in form and detail of the invention as shown and described above may be made. It is intended that such changes be included within the spirit and scope of the claims appended hereto.

This application is based on Japanese Patent Application No. 2008-63509 filed Mar. 13, 2008, incorporated herein by reference in its entirety.

What is claimed is:

1. A sensor control apparatus connectable to a gas sensor, the sensor including a detection element for detecting concentration of a specific gas in a to-be-measured gas, and a heater for heating the detection element to an element activation temperature, the sensor control apparatus comprising:
a signal processing circuit which controls supply of electricity to the detection element and detects a voltage signal output from the detection element corresponding to the concentration of the specific gas;
a heater control circuit which controls supply of electricity to the heater; and
a communication circuit which outputs, as a concentration signal, the voltage signal detected by the signal processing circuit to a first external device by means of serial communication, wherein
the signal processing circuit, the heater control circuit, and the communication circuit are implemented on a common circuit board;
a power-system ground to which the heater control circuit is connected and a signal-system ground to which the signal processing circuit and the communication circuit are connected are independently provided on the circuit board; and
the signal-system ground includes a first electrical path which establishes electrical connection between the circuit board and the first external device, and the power-system ground includes a second electrical path which is provided independently of the first electrical path and establishes electrical connection between the circuit board and a second external device different from the first external device.

2. The sensor control apparatus according to claim 1, wherein the gas sensor is an NO_{X} sensor for detecting concentration of NO_{X} as the concentration of the specific gas in the to-be-measured gas.

3. The sensor control apparatus according to claim 1, wherein the sensor control apparatus controls a sensor of an internal combustion engine; the first external device is an engine control unit for controlling the internal combustion engine; and the second external device is a battery for supplying electric power to the heater and the sensor control apparatus.

4. A sensor control system, comprising:
a gas sensor including a detection element for detecting concentration of a specific gas in a to-be-measured gas, and a heater for heating the detection element to an element activation temperature; and
a sensor control apparatus connected to the gas sensor, the sensor control apparatus comprising:
a signal processing circuit which controls supply of electricity to the detection element and detects a voltage signal output from the detection element corresponding to the concentration of the specific gas;
a heater control circuit which controls supply of electricity to the heater; and
a communication circuit which outputs, as a concentration signal, the voltage signal detected by the signal processing circuit to a first external device by means of serial communication, wherein
the signal processing circuit, the heater control circuit, and the communication circuit are implemented on a common circuit board;
a power-system ground to which the heater control circuit is connected and a signal-system ground to which the signal processing circuit and the communication circuit are connected are independently provided on the circuit board; and
the signal-system ground includes a first electrical path which establishes electrical connection between the circuit board and the first external device, and the power-system ground includes a second electrical path which is provided independently of the first electrical path and establishes electrical connection between the circuit board and a second external device different from the first external device.
